(19) United States
(12) Patent Application Publication
(10) Pub. No.: US 2008/0218675 A1
(43) Pub. Date: Sep. 11, 2008

(54) Liquid crystal display panel having dielectric spacers

(75) Inventors: Chao-Chih Lai, Miao-Li (TW); Tsau-Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/074,832

(22) Filed: Mar. 5, 2008

(30) Foreign Application Priority Data
Mar. 5, 2007 (TW) 96107459

(51) Int. Cl. G02F 1/1337

(52) U.S. Cl. 349/123; 349/155

(57) ABSTRACT

An exemplary liquid crystal display panel (1) includes an upper substrate (111) and a lower substrate (121) parallel to each other, a liquid crystal layer (10) sandwiched between the upper and the lower substrates, and data lines (13) and driving lines (14) formed at the lower substrate. The data lines and the driving lines cross each other, thereby defining pixel regions. Each of the pixel regions includes a first spacer (17) and a second spacer (18). The first spacer is arranged between the upper substrate and the corresponding data line. The second spacer is arranged between the upper substrate and the corresponding driving line. A predetermined gap is defined between the first spacer and the data line.

### FIELD OF THE INVENTION

The present invention relates to liquid crystal display (LCD) panels, and particularly to an LCD panel having dielectric spacers.

### BACKGROUND

A conventional LCD is capable of displaying a clear and sharp image through thousands or even millions of pixels that make up the complete image. The LCD has thus been applied to various electronic equipment in which messages or pictures need to be displayed, such as mobile phones and notebook computers. An LCD panel is a major component of the LCD. The LCD panel generally includes a lower substrate, an upper substrate parallel to the lower substrate, and a liquid crystal layer sandwiched between the two substrates.

Referring to FIGS. 6 and 7, these show aspects of a conventional LCD panel. The LCD panel 3 includes an upper substrate assembly 31, and a lower substrate assembly 32 generally parallel to the upper substrate assembly 31. The lower substrate assembly 32 includes a multiplicity of data lines 33 arranged parallel to each other and each extending in a same direction, and a multiplicity of driving lines 34 arranged parallel to each other and each extending in a direction perpendicular to the data lines 33. Thereby, the data lines 33 and driving lines 34 cooperatively define a multiplicity of pixel regions (only one shown, not labeled). Each of the pixel regions includes a pixel electrode 36, and a thin film transistor (TFT) 35 arranged at an intersection of a corresponding one of the data lines 33 and a corresponding one of the driving lines 34. The driving line 34 provides driving signals to switch the TFT 35. The data line 33 provides data signals to the pixel electrode 36 via the TFT 35.

FIG. 7 is a cross-sectional view corresponding to line VII-VII of FIG. 6. The upper substrate assembly 31 includes a glass substrate 311, a common electrode 312, and an alignment film 313 arranged in that order from top to bottom. The LCD panel 3 further includes a multiplicity of spacers 37 (only one shown) and a liquid crystal layer 30. Each spacer 37 is arranged on the corresponding TFT 35. The spacers 37 thereby cooperatively maintain a gap between the upper substrate assembly 31 and the lower substrate assembly 32, for containing the liquid crystal layer 30.

In operation, parasitic capacitors are formed between the common electrode 312 and the data lines 33, and/or between the common electrode 312 and the driving lines 34. The liquid crystal layer 30 functions as dielectric material between the common electrode 312 and the data lines 33, and/or between the common electrode 312 and the driving lines 34. However, in each pixel region, when electrical signals are provided to the common electrode 312, the date line 33, and the driving line 34, an electric field generated by the electrical signals re-orientates the liquid crystal molecules and changes a dielectric constant of the liquid crystal layer 30. Thus, a capacitance of the parasitic capacitor(s) is varied. The variation of the parasitic capacitor(s) is hard to control, and this typically causes distortion of the electrical signals. Accordingly, a display quality of the LCD panel 3 is liable to be reduced.

Also, the upper substrate assembly 31 and the lower substrate assembly 32 are separated by the spacers 37, with a fixed gap provided between the upper substrate assembly 31 and the lower substrate assembly 32. If superfluous liquid crystal material is dropped into the LCD panel 3 to form the liquid crystal layer 30, the liquid crystal material may exert an unduly large pressure. If the pressure is over a critical threshold, the inner structure of the LCD panel 3 is liable to be damaged. For example, some of the TFTs 35 and pixel electrodes 36 may be damaged. Accordingly, the reliability and performance of the LCD panel 3 may be impaired.

Thus, what is needed is an LCD panel that can overcome the above-described deficiencies.

### SUMMARY

In one embodiment, a liquid crystal display panel includes an upper substrate and a lower substrate parallel to each other, a liquid crystal layer sandwiched between the upper and the lower substrates, and a plurality of driving lines and a plurality of data lines formed at the lower substrate. The driving lines and the data lines cross each other thereby defining a plurality of pixel regions. Each of the pixel regions includes at least a first spacer and a second spacer. The at least one first spacer is arranged between the upper substrate and the data line. The second spacer is arranged between the upper substrate and lower substrate. A predetermined gap is defined between the each of the at least one first spacers and the data line.

In another embodiment, a liquid crystal display panel includes a substrate and a common electrode substrate generally parallel to each other, a liquid crystal layer sandwiched between the substrate and the common electrode substrate, a plurality of driving lines and a plurality of data lines formed at the substrate, and a plurality of dielectric members arranged between the common electrode substrate and the driving lines, or/and between the common electrode and the data lines. The dielectric members are made of material with lower dielectric constant than that of the liquid crystal layer.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a top plan view of part of an LCD panel according to a first embodiment of the present invention.

FIG. 2 is a side, cross-sectional view of part of the LCD panel of the first embodiment, corresponding to line II-II of FIG. 1, and further showing an upper substrate assembly and a liquid crystal layer of the LCD panel.

FIG. 3 is a side, cross-sectional view of part of the LCD panel of the first embodiment, corresponding to line III-III of FIG. 1, and further showing the upper substrate assembly and the liquid crystal layer of the LCD panel.

FIG. 4 is a top plan view of part of an LCD panel according to a second embodiment of the present invention.

FIG. 5 is a top plan view of part of an LCD panel according to another embodiment of the present invention.

FIG. 6 is a top plan view of part of a conventional LCD panel.

FIG. 7 a side, cross-sectional view of part of the conventional LCD panel of FIG. 6, corresponding to line VII-VII thereof, and further showing an upper substrate assembly and a liquid crystal layer of the LCD panel.

### DETAILED DESCRIPTION OF PREFERRED EMBODIMENTS

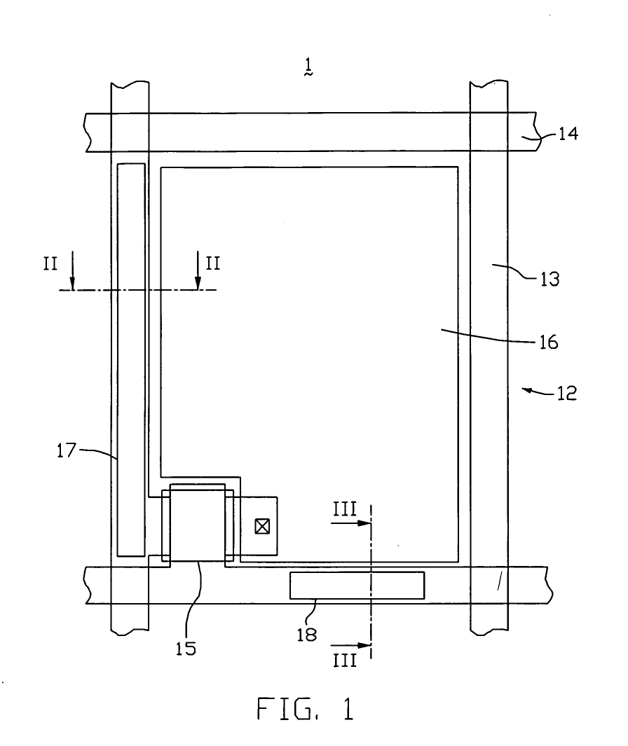

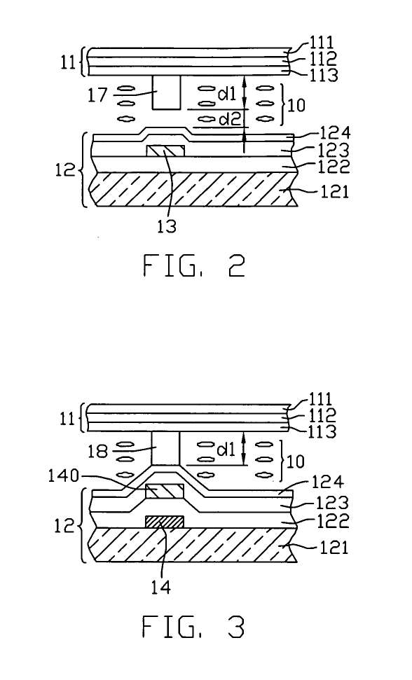

Referring to FIGS. 1 and 2, these show aspects of an LCD panel according to a first embodiment of the present invention. The LCD panel 1 includes an upper substrate assembly 11, and a lower substrate assembly 12 generally parallel to the upper substrate assembly 11. The lower substrate assembly 12 includes a multiplicity of data lines 13 arranged parallel to each other and each extending in a same direction, and a multiplicity of driving lines 14 arranged parallel to each other and each extending in a direction perpendicular to the data lines 13. Thereby, the data lines 13 and driving lines 14 cooperatively define a multiplicity of pixel regions (only one shown, not labeled). Each of the pixel regions includes a pixel electrode 16, and a TFT 15 arranged at an intersection of a corresponding one of the data lines 13 and a corresponding one of the driving lines 14. The driving line 14 provides driving signals to switch the TFT 15. The data line 13 provides data signals to the pixel electrode 16 via the TFT 15. A first spacer 17 with a rectangular shape is formed above the data line 13, and extends along a length corresponding to a length of the data line 13 at the pixel region. A second spacer 18 with a rectangular shape is formed above the driving line 14, and extends along a length corresponding to part of a length of the driving line 14 at the pixel region.

FIG. 2 is a cross-sectional view corresponding to line II-II of FIG. 1. The liquid crystal layer 10 is disposed between the upper substrate assembly 11 and the lower substrate assembly 12. The upper substrate assembly 11 includes an upper substrate 111, a common electrode 112, and an upper alignment film 113 arranged in that order from top to bottom. The upper substrate 111 can for example be made of glass or plastic. The common electrode 112 can for example be made of transparent metallic oxide, such as indium tin oxide (ITO) or the like. The lower substrate assembly 12 includes a lower substrate 121, a first insulating layer 122, a second insulating layer 123, and a lower alignment film 124 arranged in that order from bottom to top. The data line 13 is formed between the first insulating layer 122 and the second insulating layer 123.

The first spacer 17 is formed on the upper alignment film 113, and is parallel to the data line 13. The first spacer 17 has a height d1. The height d1 is less than a thickness of the liquid crystal layer 10. A gap d2 is defined between a bottom end (not labeled) of the first spacer 17 and the lower alignment film 124.

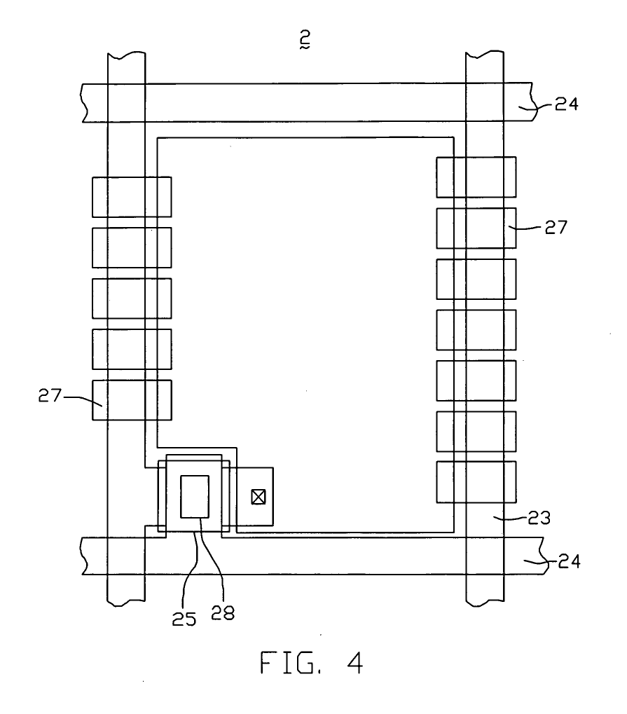

Also referring to FIG. 3, this is a cross-sectional view corresponding to line III-III of FIG. 1. The driving line 14 is formed directly on the lower substrate 121, and is covered by the first insulating layer 122. The lower substrate assembly 12 further includes an intermediate strip 140. The intermediate strip 140 is formed between the first insulating layer 122 and the second insulating layer 123, above the driving line 14. The intermediate strip 140 can be made of the same material as the data line 13, and can be made with the data line 13 simultaneously. Because of the intermediate strip 140, a high protrusion (not labeled) is formed at a portion of the lower substrate assembly 12 where the driving line 14 is formed. The second spacer 18 is formed on the upper alignment film, and is parallel to the intermediate strip 140 and the driving line 14. The second spacer 18 has the height d1. A bottom end (not labeled) of the second spacer 18 contacts the protrusion of the lower substrate assembly 12. Thus, all the pairs of second spacers 18 and corresponding protrusions cooperatively provide a fixed gap for containing the liquid crystal layer 10.

The first spacers 17 and the second spacers 18 can both be made of insulating material. The insulating material has a lower and steadier dielectric constant than that of the liquid crystal layer 10, in order to reduce parasitic capacitors formed between the common electrode 112 and the data lines 13, and/or between the common electrode 112 and the driving lines 14.

Unlike with the above-described conventional LCD panel 3, the LCD panel 1 has in each pixel region the first spacer 17 formed between the common electrode 112 and the data line 13, and the second spacer 18 formed between the common electrode 112 and driving line 14. Due to the lower dielectric constant of the first spacer 17 and the second spacer 18, parasitic capacitors formed between the common electrode 112 and the data line 13, and/or between the common electrode 112 and the driving line 14, are reduced. Due to the steadier dielectric constant of the first spacer 17 and the second spacer 18, the reduced parasitic capacitors are also steady. Thus when the LCD panel 1 is in operation, distortion of signals caused by the parasitic capacitors is reduced and is easier to be control. This facilitates the displaying of images with higher quality.

Furthermore, the gap d2 is defined between the first spacer 17 and the lower substrate assembly 12. When liquid crystal material is filled into the LCD panel 1 to form the liquid crystal layer 10, the gaps d2 function as buffer zones for accommodating and allowing the passage of excrescent portions of the liquid crystal material. Accordingly, excessive pressure caused by any excrescent portions of the liquid crystal material is avoided. Consequently, any damage that may be caused to the LCD panel 1 by such excessive pressure is avoided.

In summary, the LCD panel 1 not only provides improved display quality, but also has higher reliability and durability.

FIG. 4 is a top plan view of part of an LCD panel according to a second embodiment of the present invention. The LCD panel 2 has a similar structure to that of the LCD panel 1. However, each pixel region (only one shown, not labeled) includes a plurality of first spacers 27 and a second spacer 28. The first spacers 27 and the second spacer 28 are formed on an upper substrate assembly (not shown). The first spacers 27 are opposite to a corresponding one of the data lines 23. (In FIG. 4, the first spacers 27 of two adjacent regions are shown.) A gap (not shown) is defined between each first spacer 27 and a lower substrate assembly 22. Each of the first spacers 27 has a rectangular or square shaped structure. Alternatively, the first spacers 27 may include a mixture of rectangular and square shaped structures. The first spacers 27 are arranged in a line over the data line 23. An interval (not labeled) is defined between each two adjacent first spacers 27. In the illustrated embodiment, widths of the intervals separating the first spacers 27 are uniform.

The second spacer 28 directly contacts the upper substrate assembly and the lower substrate assembly 22, thereby maintaining a gap between the upper substrate assembly and the lower substrate assembly 22 for containing liquid crystal material. The second spacer 28 is located on the TFT 25.

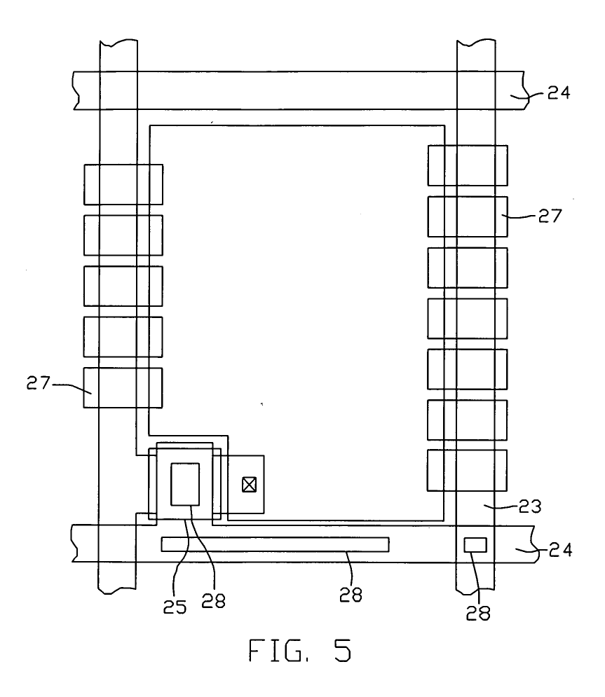

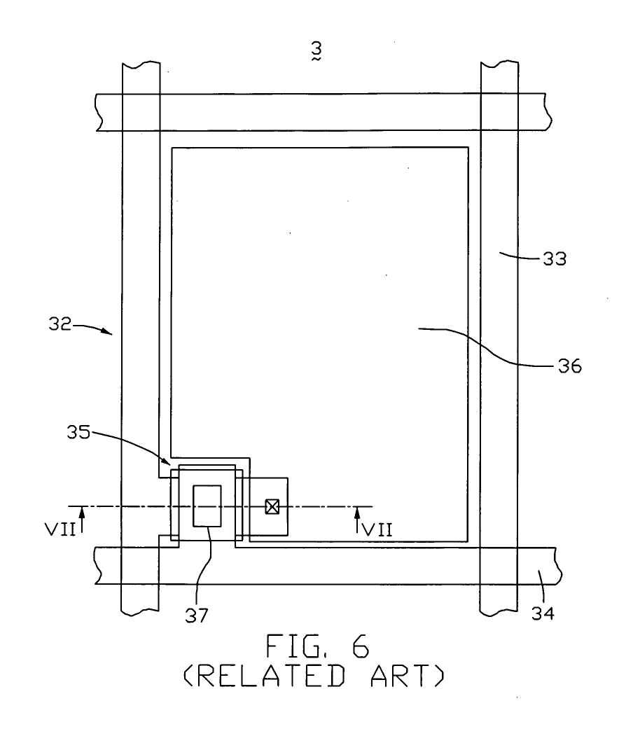

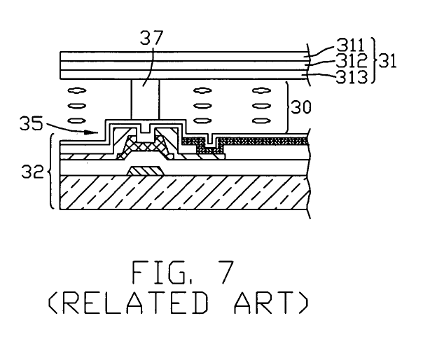

In alternative embodiments, the second spacer 28 can be shaped or positioned otherwise. For example, the second spacer 28 can be elongate, and located over a corresponding one of the driving lines 24. In another example, the second spacer 28 can be rectangular, and located above an intersection area of a corresponding one of the data lines 23 and a corresponding one of the driving lines 24. Referring to FIG. 5, this shows part of an LCD panel 4 similar to the LCD panel 2. However, the LCD panel 4 includes three second spacers 28 in each pixel region (only one shown, not labeled). One of the second spacers 28 is located at the same position as the second spacer 28 of the LCD panel 2. The other two second spacers 28 are located at the two above-described exemplary positions (as shown in FIG. 5).

In further alternative embodiments, in the LCD panel 1, a plurality of gaps are defined according to at least one of the following arrangements: a gap is defined between each of at least a plurality of the plurality of first spacers 17 and the corresponding data lines 13, and a gap is defined between each of at least a plurality of the plurality of second spacers 18 and the corresponding driving lines 14. In the LCD panel 2, a gap is defined between each of at least a plurality of the plurality of first spacers 27 and the corresponding data lines 23, a gap is defined between each of at least a plurality of the plurality of second spacers 28 and the corresponding driving lines 24.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display panel, comprising:
an upper substrate and a lower substrate parallel to each other;
a liquid crystal layer sandwiched between the upper and lower substrates; and
a plurality of driving lines and a plurality of data lines formed at the lower substrate, the plurality of driving lines and the plurality of data lines crossing each other thereby defining a plurality of pixel regions;
wherein each of the pixel regions comprises at least one first spacer and a second spacer, the at least one first spacer is arranged between the upper substrate and a corresponding one of the data lines, the second spacer is arranged between the upper substrate and the lower substrate, and a predetermined gap is defined between each of the at least one first spacer and the corresponding data line.

2. The liquid crystal display panel as claimed in claim 1, wherein the at least one first spacer is made of insulating material having a lower and steadier dielectric constant than that of the liquid crystal layer.

3. The liquid crystal display panel as claimed in claim 1, wherein the second spacer is arranged corresponding to the driving line.

4. The liquid crystal display panel as claimed in claim 3, wherein the second spacer is made of insulating material having a lower and steadier dielectric constant than that of the liquid crystal layer.

5. The liquid crystal display panel as claimed in claim 3, wherein each pixel region further comprises an intermediate strip arranged between the second spacer and the driving line.

6. The liquid crystal display panel as claimed in claim 5, wherein the intermediate strip is made of insulating material.

7. The liquid crystal display panel as claimed in claim 5, wherein the intermediate strip and the data lines are made of the same material.

8. The liquid crystal display panel as claimed in claim 1, wherein the second spacer is arranged at an intersection of a corresponding one of the driving lines and another corresponding one of the data lines different from said corresponding one of the data lines.

9. The liquid crystal display panel as claimed in claim 1, wherein each pixel region further comprises a switching member, the second spacer being arranged at the switching member.

10. The liquid crystal display panel as claimed in claim 1, wherein each of the at least one first spacer and the second spacer has a rectangular shape or a square shape.

11. The liquid crystal display panel as claimed in claim 1, further comprising a common electrode and an upper alignment film arranged at an inner side of the upper substrate, the upper alignment film being nearer to the liquid crystal layer.

12. The liquid crystal display panel as claimed in claim 12, wherein the at least one first spacer and the second spacer are arranged on the alignment film.

13. A liquid crystal display panel, comprising:
a first substrate and a common electrode substrate arranged parallel to each other;
a liquid crystal layer sandwiched between the first substrate and the common electrode substrate;
a plurality of driving lines and a plurality of data lines formed at the first substrate; and
a plurality of dielectric members arranged between the common electrode substrate and the driving lines, and between the common electrode substrate and the data lines, the dielectric members being made of material having a lower dielectric constant than that of the liquid crystal layer.

14. The liquid crystal display panel as claimed in claim 13, wherein a plurality of gaps are defined according to at least one of the following arrangements: a gap is defined between each of at least a plurality of the plurality of dielectric members and the corresponding driving lines, and a gap is defined between each of at least a plurality of the plurality of dielectric members and the corresponding data lines.

15. The liquid crystal display panel as claimed in claim 13, wherein the driving lines and the data lines cross each other, thereby defining a plurality of pixel regions.

16. The liquid crystal display panel as claimed in claim 15, wherein each of the dielectric members has a shape selected from the group consisting of a strip shape, a rectangular shape, and a square shape, and is positioned according to at least one of the following arrangements: the dielectric member is positioned corresponding to a respective one of the driving lines, the dielectric member is positioned corresponding to a respective one of the data lines.
